(19) United States
(12) Patent Application Publication
(10) Pub. No.: US 2025/0150738 A1
(43) Pub. Date: May 8, 2025

(54) FLAT LOUDSPEAKER MODULE AND ARRANGEMENT HAVING SOUND-INFLUENCING MODULES

(71) Applicant: Svetlomir ALEKSANDROV, Hannover (DE)

(72) Inventor: Svetlomir ALEKSANDROV, Hannover (DE)

(21) Appl. No.: 18/835,883

(22) PCT Filed: Jan. 30, 2023
(86) PCT No.: PCT/EP2023/052190

§ 371 Date: Aug. 5, 2024

(30) Foreign Application Priority Data
Feb. 9, 2022 (DE) 10 2022 102 983.2

(51) Int. Cl. H04R 1/02; H04R 1/34; H04R 9/02; H04R 9/06

(52) U.S. Cl. CPC H04R 1/025; H04R 1/345; H04R 9/025; H04R 9/063

(57) ABSTRACT

The present invention discloses a flat loudspeaker module (1) having a loudspeaker module housing (2) and at least one loudspeaker driver (7), wherein the at least one loudspeaker driver (7) in each case has a loudspeaker chassis (8), a diaphragm (12) and a magnetic driver (9) which is coupled to the diaphragm (12) for the purpose of exciting vibrations and is arranged in front of the diaphragm (12) on the loudspeaker front side forming the sound outlet side. The loudspeaker chassis (8) has fastening means (13) for fastening the loudspeaker to the loudspeaker module housing (2) on the loudspeaker rear side diametrically opposite the sound outlet side.

The invention relates to a flat loudspeaker module with a loudspeaker module housing and at least one loudspeaker driver, wherein the at least one loudspeaker driver in each case has a loudspeaker chassis, a diaphragm and a magnetic driver which is coupled to the diaphragm for the purpose of exciting vibration and is arranged in front of the diaphragm on the loudspeaker front side forming the sound outlet side.

The invention further relates to an arrangement with multiple separately functional sound-influencing modules which have a flat module housing with a depth that is the same for all sound-influencing modules, such as, for example, a flat loudspeaker arrangement with a frame in which at least one such flat loudspeaker module is accommodated.

There is a need for flat loudspeaker modules that can be hung on the wall while ensuring outstanding sound quality.

Flat loudspeaker drivers are necessary for this purpose.

DE 41 26 121 A1 discloses a dynamic loudspeaker, in particular for use in motor vehicles, with a loudspeaker chassis which carries a cone diaphragm, in the center of which is located a moving voice coil which engages in an air gap between magnetic poles of a permanent magnet which is arranged in the cone diaphragm on the side of the sound outlet.

DE 47089 A discloses a flat loudspeaker in which the magnetic driver is arranged in front of the concave side of the diaphragm as completely as possible in the cavity of the diaphragm. The diaphragm driver in this case is positioned within the cavity of the diaphragm on the concave side.

WO 2010/142315 A1 describes a loudspeaker with a centered lip in which the voice coil surrounds only one magnet in the center. The central magnet system is surrounded by the diaphragm, which is coupled to the coil and driven by it. The magnets protrude above and below the plane of the diaphragm.

On this basis, it is the object of the present invention to create an improved flat loudspeaker module and an improved flat loudspeaker arrangement.

The object is achieved with the flat loudspeaker module having the features of claim 1 and with the flat loudspeaker arrangement having the features of claim 13. Advantageous embodiments are described in the dependent claims.

For a generic flat loudspeaker module, it is proposed that the loudspeaker chassis has fastening means for fastening the loudspeaker driver to the loudspeaker housing on the loudspeaker rear side, which is diametrically opposite the sound outlet side.

By attaching the loudspeaker driver to the rear side of the loudspeaker housing, an improved integration of the loudspeaker driver into the loudspeaker housing is achieved, which reduces disturbing vibrations.

The loudspeaker chassis can be connected to a metal plate using the fasteners. The metal plate can be connected to the loudspeaker housing at opening edges on the back of the loudspeaker housing. This makes it possible to further reduce the depth of the flat loudspeaker module and optimize the sound-optimized integration of the flat loudspeaker driver into the loudspeaker housing. For this purpose, the rear side of the loudspeaker driver protrudes into an opening in the rear wall of the loudspeaker housing. The metal plate connected to the loudspeaker driver covers this opening and is connected to the loudspeaker housing at the opening edges. The loudspeaker driver is thus indirectly connected to the loudspeaker housing, which is usually made of wood, via the metal plate. The thickness of the metal plate is usually smaller than the thickness of the rear wall of the loudspeaker housing or the thickness of the opening, so that the installation depth is reduced by the difference in material thicknesses compared to installing the loudspeaker driver directly on the inside of the rear wall of the loudspeaker housing.

This metal plate not only optimizes installation and maintenance, it also improves the acoustic coupling between the loudspeaker driver and the loudspeaker housing.

The fastening means on the loudspeaker driver can, for example, have threaded openings to accommodate a fastening screw. Conceivable for this purpose is, for example, an internal thread to accommodate a machine screw or just a simple hole for a positive connection using a sheet-metal screw. The fastening means can also be a simple hole, with the metal plate being positively connected to the metal plate by means of rivets. Other positive, non-positive or material-locking connections are also conceivable for the fastening means in order to connect the loudspeaker driver directly or indirectly to the rear wall of the loudspeaker housing. This is preferably a connection that can be removed and reattached in a nondestructive manner.

At least one of the loudspeakers may have a central air duct extending from the loudspeaker rear side to the loudspeaker front side forming the sound outlet side, and through the magnetic driver. This allows for improved cooling of the loudspeaker module without increasing the depth of the flat loudspeaker module and impairing the acoustics.

A fan can be installed in such an air duct. This improves cooling through forced convection. The fan can also be used to regulate the air flow as needed.

At least one of the loudspeakers can also be connected to the front side of the loudspeaker housing with its loudspeaker chassis. For this purpose, the outer edge region of the loudspeaker chassis can be positively connected to the loudspeaker housing in the usual way, for example by screwing it in.

In this way, the loudspeaker driver can be integrated into the loudspeaker housing in an even more stable and less vibration-prone manner.

A coaxial driver can also be arranged on the magnetic driver, which has a horn that is open towards the sound outlet side. This means that a tweeter can also be integrated into the loudspeaker driver in a space-saving manner. The increased mass of the magnetic driver improves the sound characteristics of the woofer, as disturbing harmonics are reduced during the vibration movement of the diaphragm and the magnetic driver.

The flat loudspeaker module can have at least one asymmetrical tweeter. The arrangement of the flat loudspeaker module in this way improves the sound distribution for the different listening levels and listening directions.

There can be at least one magnetic fastening element for detachably fastening a horn shell of a horn by magnetic force optionally in one of several possible orientations on the flat loudspeaker module. The radiation direction of a loudspeaker driver of the flat loudspeaker module can thus be specified by detachably fastening a suitably selected horn shell from a set of horn shells and in the orientation suitable for achieving the radiation characteristics.

The horn shell can have a complete horn with a horn neck and horn mouth. It is also conceivable that the horn is made up of multiple parts and a first part, which comprises the horn neck, is firmly mounted in the flat loudspeaker module on the associated loudspeaker driver and the horn shell has the horn mouth and forms the second part. The horn shell can then be detachably fastened by magnetic force to the associated loudspeaker driver or the adjacent area of the flat loudspeaker module, or in the multi-part version to the first part of the horn.

There may be a set of different horn shells.

A first type of horn shell can have a horn mouth that opens asymmetrically in the direction of the width of the horn shell. As a result, depending on the orientation selected for the magnetic fastening, a radiation characteristic that acts to the right or left can be produced. If the horn shell is aligned horizontally in the width direction, radiation to the right or left can be achieved by two orientations rotated 180° to one another. Otherwise, a radiation direction upwards or downwards can also be achieved by rotating the flat loudspeaker module by 90°.

A second type of horn shell can have at least one slanted crosspiece extending in the direction of the width of the horn shell. Preferably, however, several such crosspieces are provided parallel to one another and spaced apart from one another. This achieves an asymmetrical radiation characteristic in the target orientation of the flat loudspeaker module that acts upwards or downwards in the direction of the height of the horn shell, depending on the orientation selected for the magnetic fastening. The radiation upwards or downwards is determined by the two orientations that can be selected for the magnetic fastening and are rotated 180° to one another. A radiation direction to the right or left can also be achieved by rotating the flat loudspeaker module as a whole by 90°.

A third horn shell can have a symmetrically opening horn mouth. In this variant, the orientation of the magnetic fastening to the flat loudspeaker module is irrelevant.

In an arrangement with multiple separately functioning sound-influencing modules that have a flat module housing with a depth that is the same for all sound-influencing modules, the sound-influencing modules can be selected from the group of active flat loudspeaker modules, absorber modules and/or diffuser modules. The sound-influencing modules have fastening elements arranged symmetrically and equally spaced at their edge regions, and the sound-influencing modules have a dimension in height and width that corresponds to a common grid dimension or a multiple thereof.

In the present invention the absorber modules and diffuser modules are passive flat loudspeaker modules, and the flat loudspeaker modules comprising loudspeaker drivers are active flat loudspeaker modules.

This means that an active or passive sound-influencing element in the form of a narrow wall surface can be created from an optional combination of sound-influencing modules that abut flush against one another and are connected to one another, which has a desired audio characteristic depending on the combination.

Due to their dimensions, the sound-influencing modules can be assembled in a grid dimension to form an arrangement with a rectangular surface, the width and height of which is determined by the number and orientation of the sound-influencing modules. Arrangements of different sizes can be implemented.

In the simplest embodiment, the sound-influencing modules of a set can be square, flat modules with a height and width corresponding to the smallest grid dimension.

However, the set can also contain rectangular sound-influencing modules that have, for example, a double grid dimension in height and a single grid dimension in width. This corresponds to two square modules with the single grid dimension arranged next to or on top of each other.

Furthermore, square sound-influencing modules with a multiple of the grid dimension can be present, such as twice the grid dimension in height and width. This corresponds to four modules with a single grid dimension joined together to form a square.

The sound-influencing modules can each be arranged in one of four different orientations in the area of the arrangement. The sound-influencing modules can have a sound-influencing characteristic that depends on the orientation (i.e., the orientation that can be varied in 90° rotations). The selected orientation allows the effect of the characteristic to be exploited in the combination of multiple sound-influencing modules and coordinated with one another in such a way that the desired effect of the arrangement is achieved.

The arrangement may have a frame in which at least one active or passive flat loudspeaker module as described above is accommodated.

The frame can be connectable to the sound-influencing modules on the periphery of the sound-influencing modules with flat module housing arranged next to one another, which are selected from the group of flat loudspeaker modules, absorber modules and/or diffuser modules, by means of fastening elements arranged in each case symmetrically and equally spaced on the frame and the sound-influencing modules.

The frame can be made up of multiple parts, wherein the multiple frame parts are connectable to the sound-influencing modules on the periphery of sound-influencing modules with flat module housings arranged next to one another, which are selected from the group of flat loudspeaker modules, absorber modules and/or diffuser modules, by means of fastening elements arranged symmetrically and equally spaced on the multiple frame parts and the sound-influencing modules.

The frame can be filled with absorber material in areas that are not utilized by flat loudspeaker modules. For this purpose, a passive absorber module can be attached adjacent to another sound-influencing module.

By arranging absorber material and/or diffusers between the loudspeaker drivers or between the loudspeaker modules, the flat loudspeaker arrangement also has an attenuating and/or sound-spreading effect on the room acoustics, in order to suppress disturbing reflections on walls and improve the room acoustics. The arrangement therefore combines active and, if necessary, passive loudspeakers with absorption panels and/or diffuser modules.

The frame can be covered with a fabric on its front side, which forms the sound outlet side. The fabric can be a user-specific printable or printed fabric. This means that the flat loudspeaker arrangement can be individually adapted to the desired room design. In this way, the flat loudspeaker arrangement not only has an acoustic effect, but also a visual effect and can be used as a room design element.

To fasten the fabric, the frame can have a groove with clamping means on the front edges or rear sections, preferably on side crosspieces, for positive and/or non-positive fastening of the fabric to the frame. The fabric stretched over the front side of the frame is pulled over the front edge of the frame and placed in the groove, where it is clamped in place with clamping means. In this way, the fabric can be easily stretched onto the frame and replaced if necessary.

The frame can have a lighting arrangement on at least one front edge or rear side edge sections. The lighting arrangement can, for example, be made of an LED strip that is fastened to the frame. The LED strip can, for example, be accommodated and fastened in a groove in the frame. Due to this lighting arrangement, the flat loudspeaker arrangement can also be used as a light to illuminate a room as required. The flat loudspeaker arrangement emits indirect light in this case.

The lighting arrangement can, for example, have light sources for several colors in order to vary the light color in this way. It is conceivable that the flat loudspeaker arrangement has a control unit which controls the lighting arrangement depending on the sound emitted. For example, the color can be controlled depending on the frequency spectrum. In a corresponding manner, the brightness of the emitted light can be controlled depending on the sound intensity, i.e. the volume.

It is also conceivable to control the light depending on the type of sound event, for example depending on the type of music (classical, pop, jazz, etc.).

The sound-influencing modules can be arranged flush next to one another. The sound-influencing modules can have fastening elements that are arranged symmetrically and equally spaced in each case on their housing, preferably on the edge region of the housing. The frame parts can also have such fastening elements that are present at fastening points aligned to a grid dimension.

The fastening elements can, for example, have threaded nuts for holding fastening screws and, if necessary, a recess for holding a fastening plate. The fastening plate can be firmly screwed to the fastening threads of the sound-influencing modules using fastening screws. This means that sound-influencing modules that are flush with one another can be firmly screwed together to form a stable surface arrangement. The frame no longer has to have a load-bearing effect when the modules are joined together in this way.

The sound-influencing modules can preferably have suspension elements or fastening elements for screwing on suspension elements, such as tabs, elbows or eyebolt holders, at their edge regions.

For example, fastening tabs that have at least one suspension hole can be screwed to a fastening point on the module, for example, one of the symmetrical and equally spaced fastening elements.

However, L-shaped elbows can also be screwed to selected fastening points on the module, such as one of the symmetrical and equally spaced fastening elements. This allows the arrangement with the L-shaped elbows to be positively hung on a wall rail mounted on a wall. This allows the position of the module to be shifted horizontally.

However, U-shaped threaded holders with a thread, a threaded bolt or a nut can also be used as suspension elements and can be screwed to a selected fastening point with the sound-influencing module, for example to one of the symmetrical, equally spaced fastening elements. This allows an eyebolt or threaded rod to be screwed into the threaded holder in order to fasten the arrangement to a supporting structure.

The fastening elements located in the edge regions of the arrangement, which are symmetrical and equally spaced on the sound-influencing modules, can also be utilized to connect separate feet. This allows feet to be screwed onto the sides and, if necessary, the bottom edge of the arrangement, for example, the foot sections of which extend transversely to the plane spanned by the module arrangement and which rest on a floor.

The invention is explained in more detail below using exemplary embodiments with reference to the accompanying drawings. In the figures:

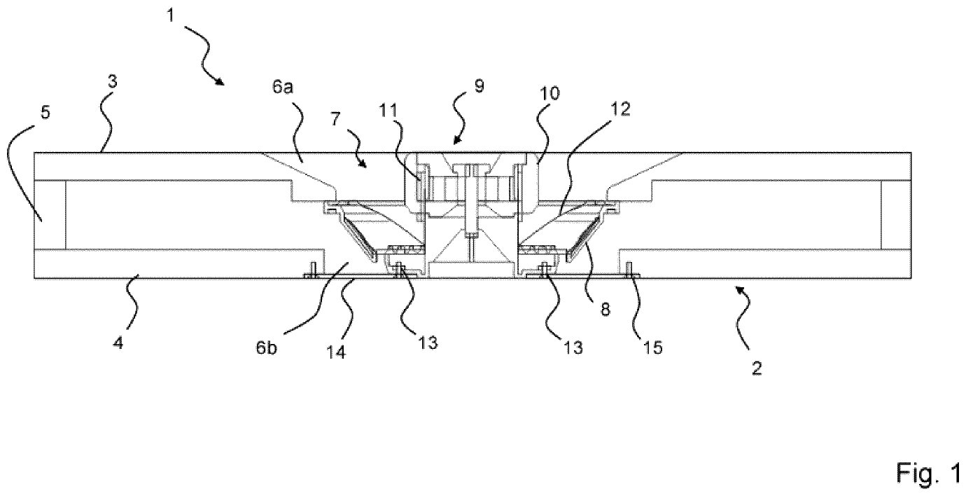

FIG. 1—shows a sectional view of a flat loudspeaker module;

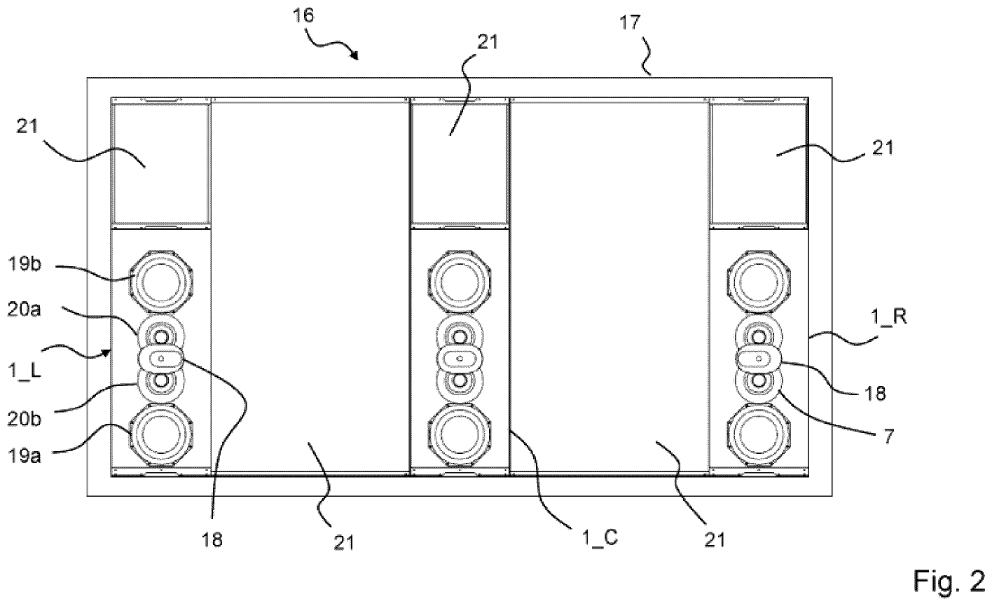

FIG. 2—shows a top view of a first embodiment of a flat loudspeaker arrangement;

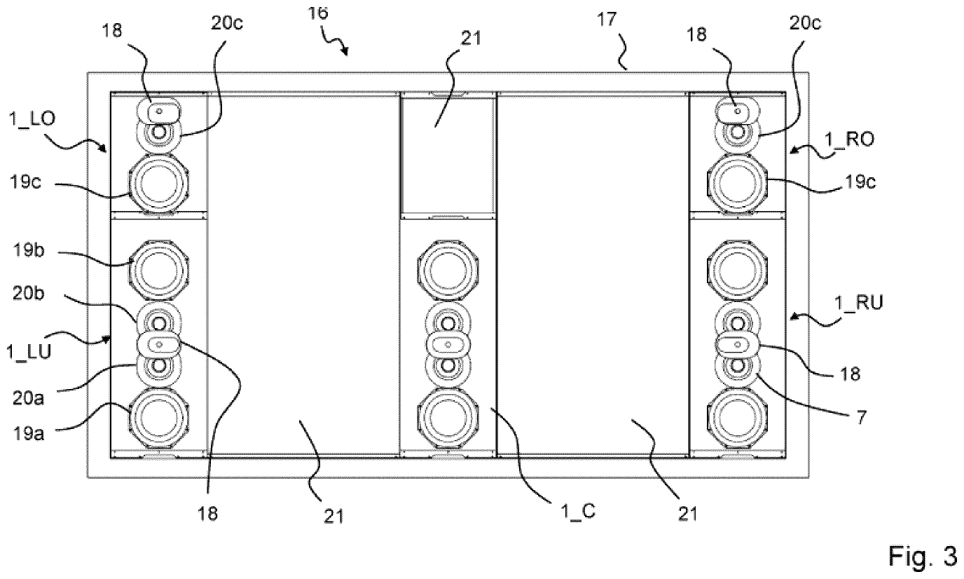

FIG. 3—shows a top view of a second embodiment of a flat loudspeaker arrangement;

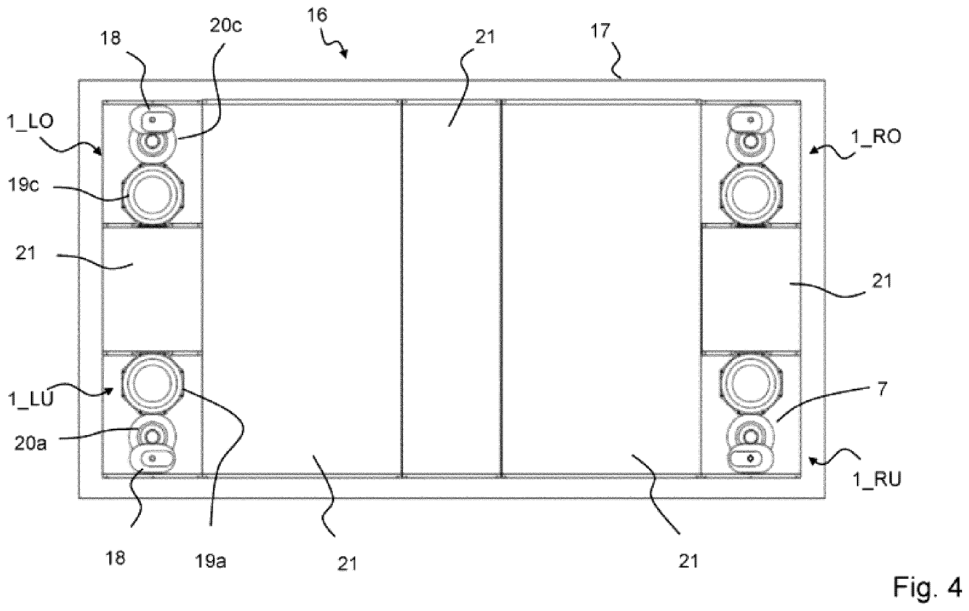

FIG. 4—shows a top view of a third embodiment of a flat loudspeaker arrangement;

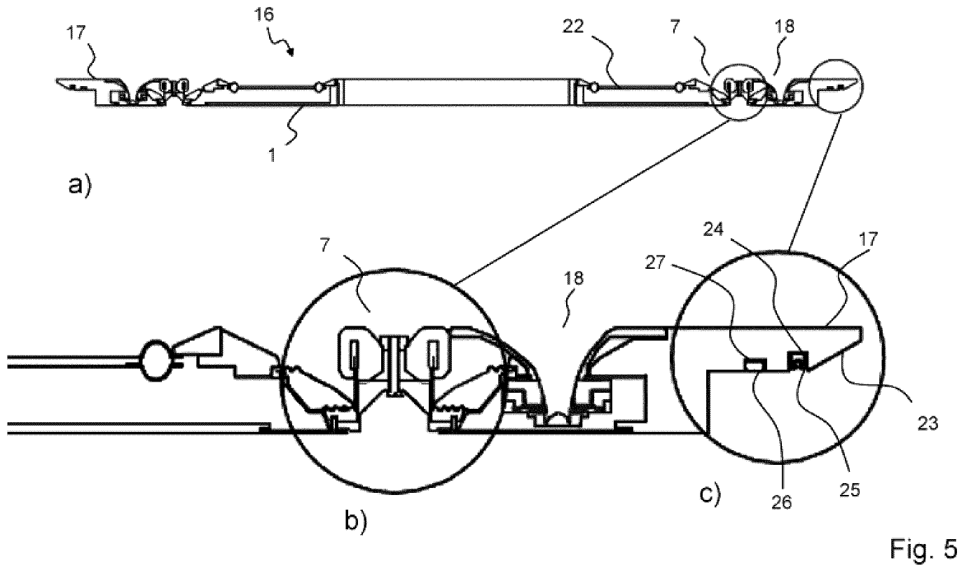

FIG. 5—shows a sectional view of a flat loudspeaker arrangement with detail views;

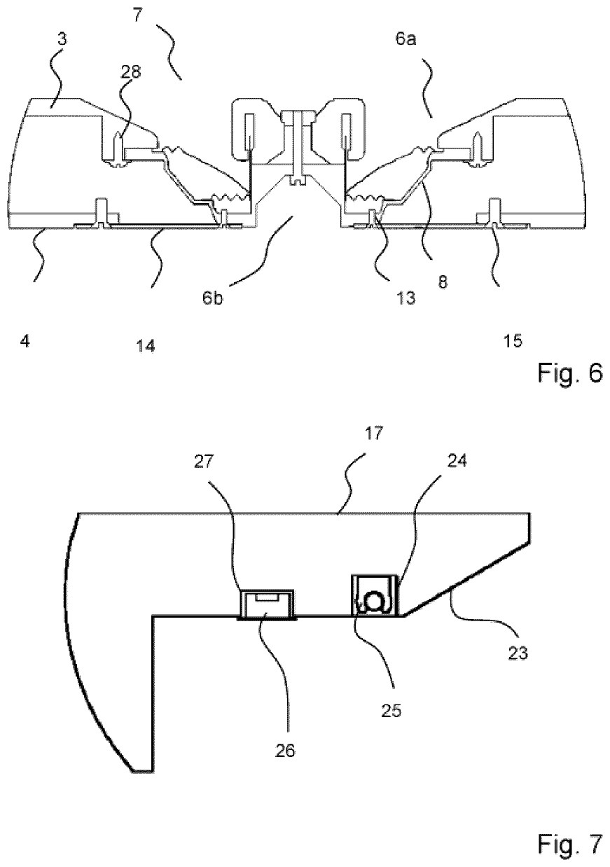

FIG. 6—shows a detail view b) of the flat loudspeaker arrangement from FIG. 5;

FIG. 7—shows a detail view c) of the flat loudspeaker arrangement from FIG. 5;

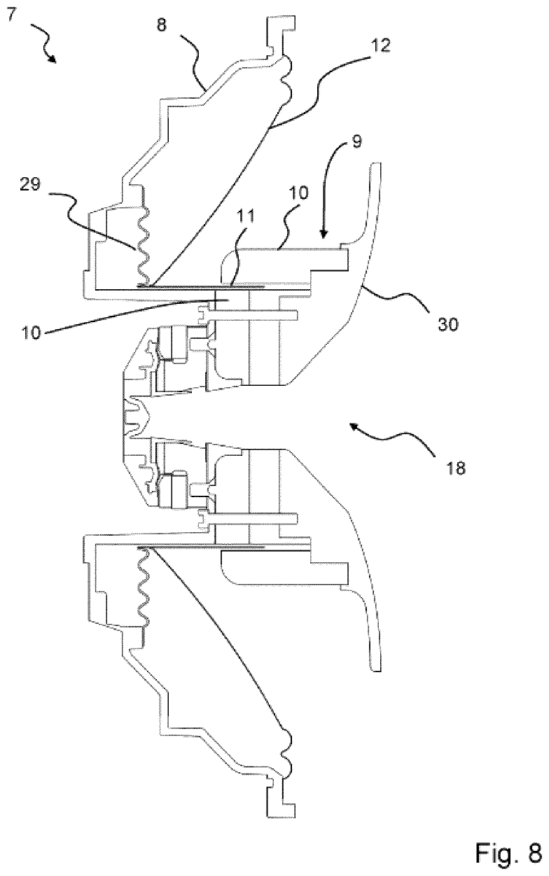

FIG. 8—shows a sectional view through a loudspeaker driver with additional coaxial driver;

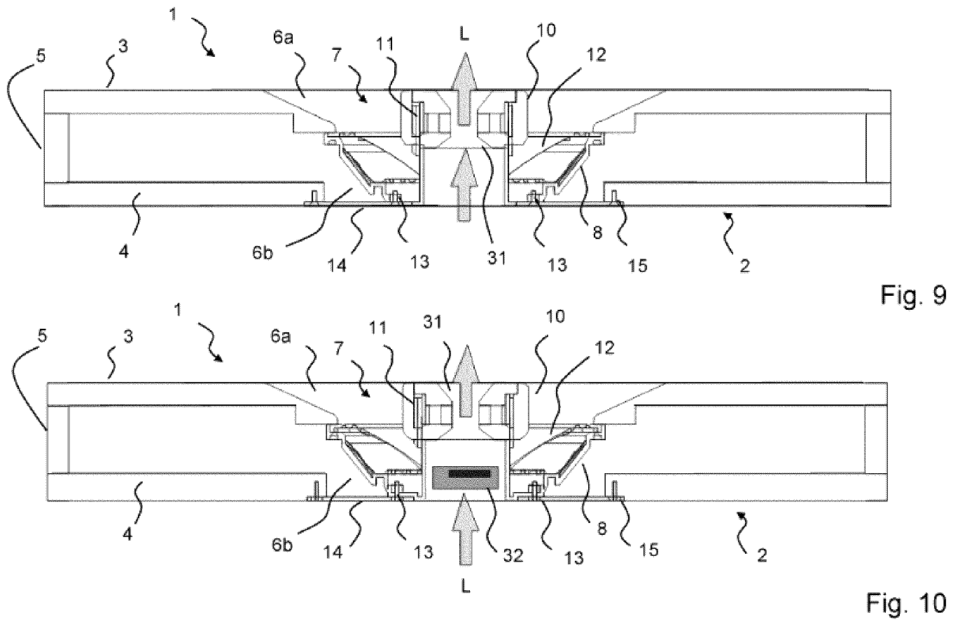

FIG. 9—shows a side view of an embodiment of the flat loudspeaker module from FIG. 1;

FIG. 10—shows a flat loudspeaker arrangement from FIG. 9 with additional fan;

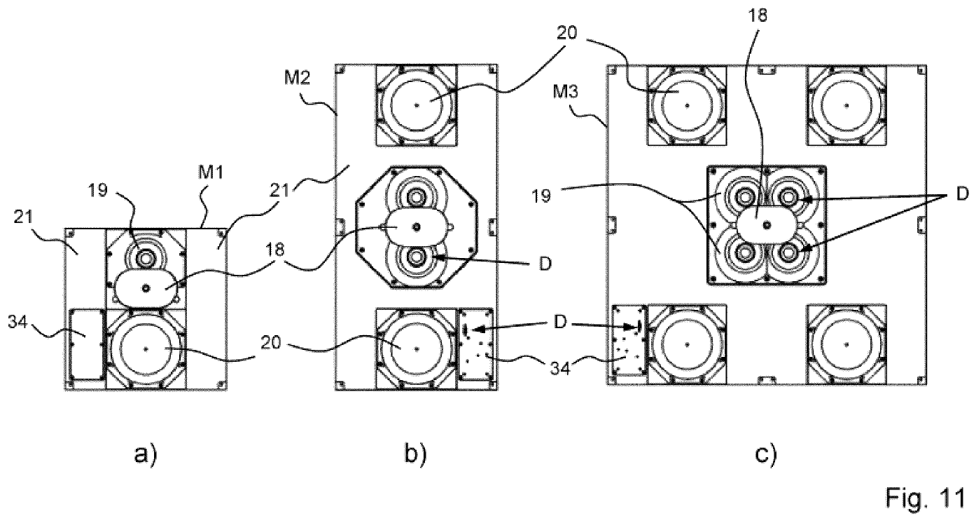

FIG. 11—shows a front view of flat panel loudspeaker modules with dimensions based on a common grid dimension;

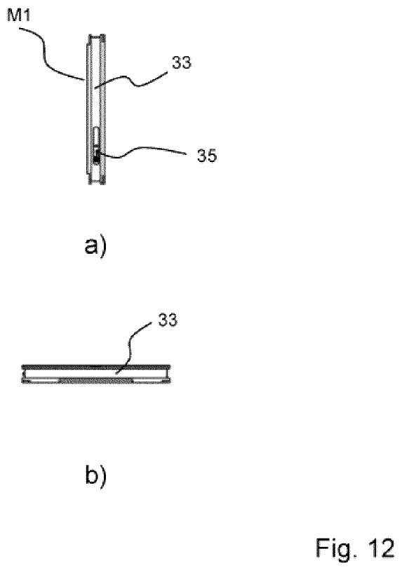

FIG. 12—shows a side view of the square flat loudspeaker module with the dimension of the grid dimension from FIG. 11;

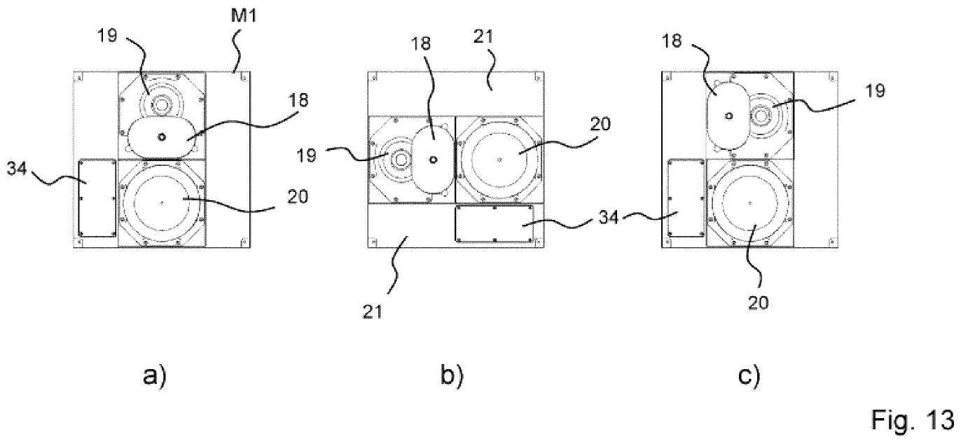

FIG. 13—shows a front view of the square flat loudspeaker module with the dimensions of the grid dimension from FIG. 11 in different orientations of the flat loudspeaker module or its loudspeaker inserts;

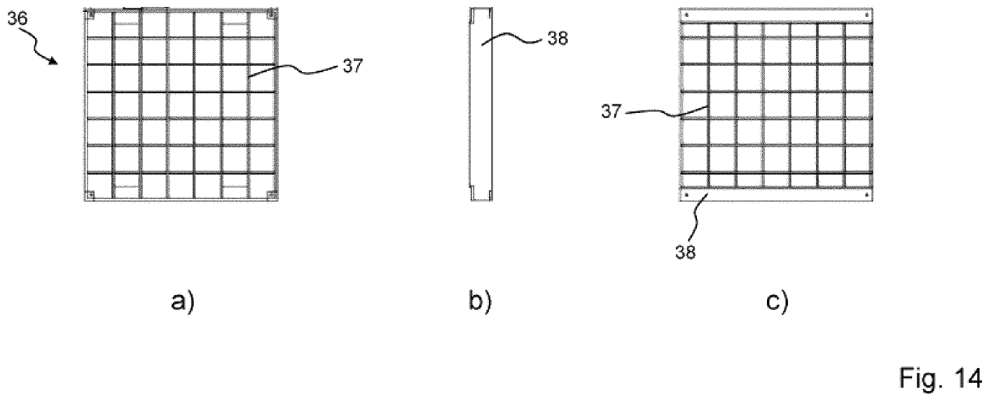

FIG. 14—shows a front, side and rear view of a diffuser module;

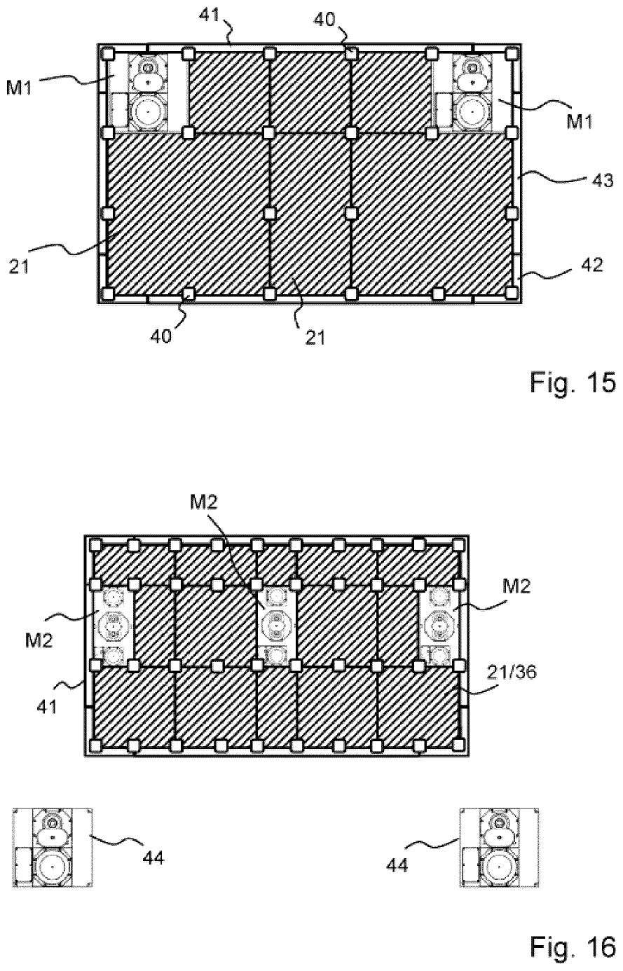

FIG. 15—shows a front view of a first variant of a flat panel loudspeaker arrangement for the 16:10 format (computer screen format);

FIG. 16—shows a front view of a second variant of a flat panel loudspeaker arrangement for the 16:9 format (HDTV) with optional monophonic loudspeaker boxes for surround sound;

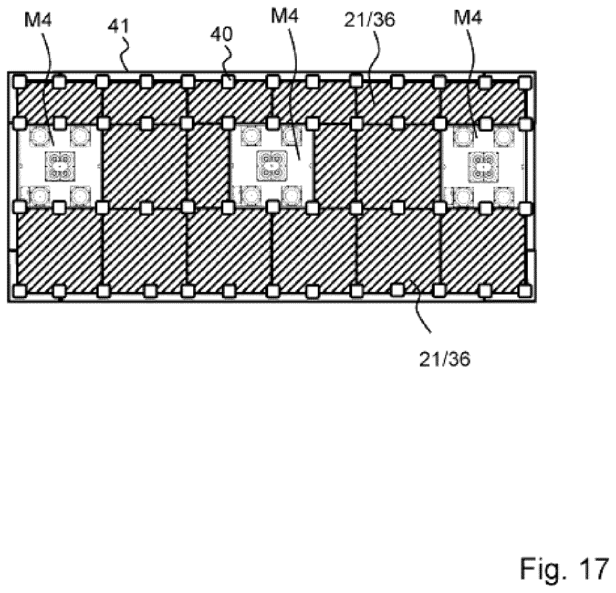

FIG. 17—shows a front view of a third variant of a flat panel loudspeaker arrangement for the cinema format;

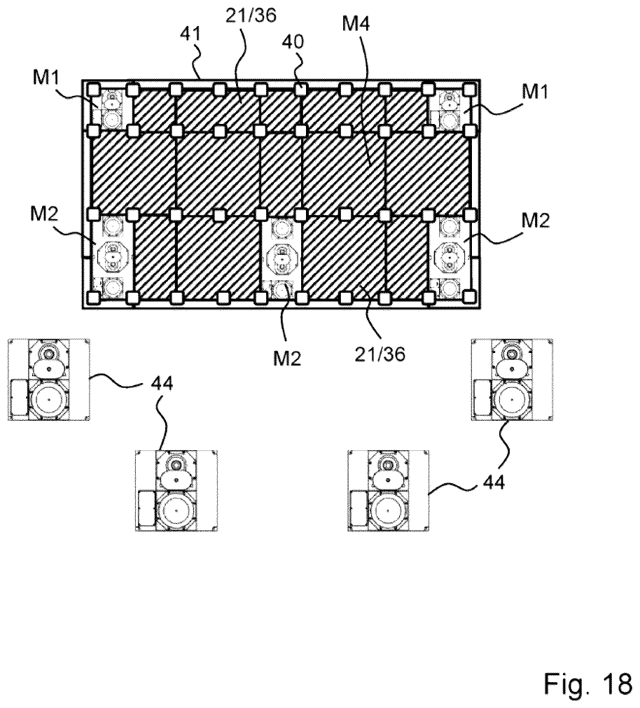

FIG. 18—shows a front view of a fourth variant of a flat panel loudspeaker arrangement for the 16:9 format with immersive, room-filling sound and optional additional monophonic loudspeaker boxes for surround sound;

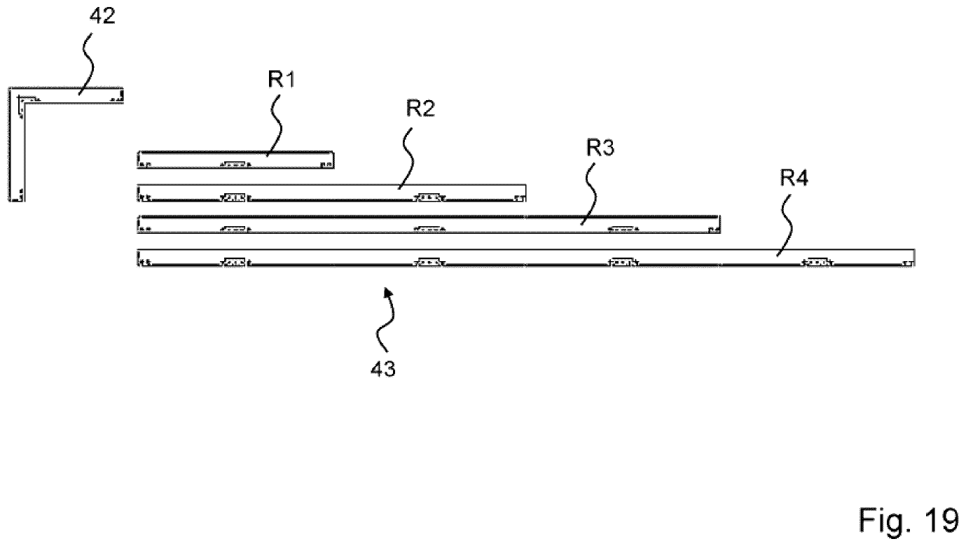

FIG. 19—shows a top view of different frame elements of a set for forming a frame for the arrangements which can be assembled in different dimensions using the grid dimension;

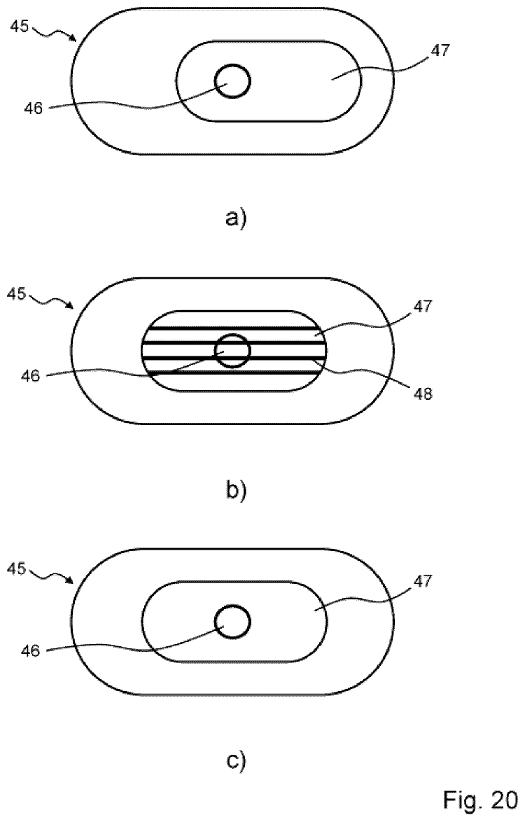

FIG. 20—shows a top view of various embodiments of horn shells;

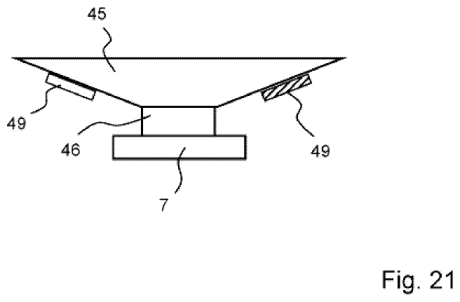

FIG. 21—shows a sketch of a horn shell with magnetic fastening above a loudspeaker driver.

FIG. 1 shows a side view of a flat loudspeaker module 1 with a module housing 2. Module housing 2 can have a front plate 3, a rear plate 4 and side walls 5 which connect front plate 3 to rear plate 4. Openings are made in front plate 3 and rear plate 4, with one loudspeaker driver 7 being accommodated in each of a pair of aligned openings 6a, 6b.

Loudspeaker driver 7 has a loudspeaker chassis 8 which carries a magnetic driver 9. Magnetic driver 9 has magnets 10 in a manner known per se and a voice coil 11 guided in a slot of magnets 10. Magnets 10 or magnet arrangement is preferably concentric, with voice coil 11 immersing into an annular slot of the concentric magnet arrangement.

Voice coil 11 is connected to a diaphragm 12 in order to excite diaphragm 12 to oscillate as it moves in magnet arrangement 10. Diaphragm 12 is connected at its outer peripheral edge to the front, outer peripheral edge of chassis 8.

Magnetic driver 9 is located on the front side of loudspeaker driver 7, completely or partially within the spatial area enclosed by diaphragm 12. It can protrude beyond the plane of loudspeaker chassis 8, which is spanned at the front side by its outer edge with the excitation of diaphragm 12 to loudspeaker chassis 8.

In the illustrated exemplary embodiment, magnetic driver 9 projects beyond the upper, front plane of loudspeaker chassis 8 to the front side of loudspeaker driver 7, which forms the sound outlet side, and also utilizes the space or its depth provided by front plate 3 of module housing 2.

Front plate 3 can have an offset into the interior of module housing 2 in the area of opening 6a in order to increase in this way the depth between the outer plane of front plate 3 and the inner fastening plane for supporting the front, outer edge of loudspeaker chassis 8.

Front opening 6a in front plate 3 can be tapered (slanted) from the outside to the interior so as not to impede the sound radiation. The shape and angle of opening 6a can be adapted to the angle of diaphragm 12 and continue the course of diaphragm 12.

Fasteners 13 are provided on the rear of chassis 8. These can be threaded holes into which a fastening screw is screwed as shown. A metal plate 14 is connected in this way to loudspeaker chassis 8 on the rear of chassis 8. Metal plate 14 abuts on the opening edges of rear opening 6b of rear plate 4 of the module housing and is screwed there to rear plate 4 with fastening screws 15.

Metal plate 14 can have an opening into which chassis 8 is immersed, wherein metal plate 14 is then connected to fastening means 13 of loudspeaker chassis 8 at the edges of the opening.

It is clear that loudspeaker driver 7 is accommodated in a module housing 2 that is as flat as possible, and makes use of openings 6a, 6b on front plate 3 and rear plate 4 for installation. Loudspeaker driver 7 is connected to module housing 2 indirectly via rear metal plate 14.

Loudspeaker driver 7 can also be screwed to front plate 3 on its front side on the front outer periphery of loudspeaker chassis 8. This is optional and further reduces the risk of distortion.

FIG. 2 shows a top view of the front side of a flat loudspeaker arrangement 16 with a frame 17 in which, for example, three flat loudspeaker modules 1_L, 1_C and 1_R are installed for the left side, the center and the right side listening level. It can be seen that each flat loudspeaker module 1_L, 1_C, 1_R in each case has multiple loudspeaker drivers 7 for the different frequency ranges, in particular bass, midrange and treble.

Tweeters 18, which can be designed as coaxial drivers with a horn that is open towards the front, for example, are aligned asymmetrically in the exemplary embodiment shown. While the horn is symmetrical in center flat loudspeaker module 1_C, the alignment of the horn for the left and right sides can be asymmetrical. It can be seen that on the right side the horn is aligned asymmetrically to the left, and on the right side the horn is aligned asymmetrically to the right.

In the exemplary embodiment illustrated, a bass loudspeaker driver 19a, 19b in each case is arranged for the lower and middle listening level in a flat loudspeaker module 1 in the lower and upper area of respective flat loudspeaker module 1. In between, for example, two midrange speakers 20a, 20b are arranged one above the other in a line, i. e. not offset laterally.

Tweeter 18, for example in the form of a coaxial driver, is then arranged between two midrange speakers 20a, 20b.

An absorber plate 21 in each case is arranged between left flat loudspeaker module 1_L and center flat loudspeaker module 1_C, as well as between center flat loudspeaker module 1_C and right flat loudspeaker module 1_R, or the space is filled with absorber material 21. Likewise, the free space between frame 17 above the respective flat loudspeaker modules 1_L, 1_C and 1_R to the upper crosspiece of frame 17 is filled with absorber material 21, for example with an absorber plate.

It is conceivable that flat loudspeaker modules 1_L, 1_C and 1_R and absorber material 21 are fastened in frame 17 by fastening means, for example by means of a positive connection. For this purpose, flat loudspeaker modules 1_L, 1_C and 1_R and absorber material 21 can be clipped between crosspieces of frame 17 and center crosspieces, for example.

FIG. 3 shows a second embodiment of flat loudspeaker arrangement 16. In this case, an additional loudspeaker module 1_LO and 1_RO in each case is included for the upper listening level on the right and left sides. These loudspeaker modules only have one bass loudspeaker 19c, one midrange speaker 20c and one tweeter 18. This means that an improved sound experience can also be provided for the upper listening level.

FIG. 4 shows a third exemplary embodiment of a flat loudspeaker arrangement 16, in which, as in the second embodiment according to FIG. 3, two loudspeaker modules 1_LU and 1_LO as well as 1_RU and 1_RO for the lower and upper listening levels in each case are arranged one above the other on the left and right sides.

Flat loudspeaker module 1_LU and 1_RU for the lower listening level in each case is, like the upper flat loudspeaker module 1_LO, 1_RO, in each case equipped with a bass driver 19a and a midrange driver 20a as well as a tweeter 18 for only one listening level.

For example, loudspeaker modules 1_LU and 1_LO or 1_RU and 1_RO in each case can be arranged mirror-symmetrically to one another, so that the bass speakers are arranged closer to one another than tweeters 18.

It can be seen that absorber material 21, for example in the form of absorber plates, is arranged between flat loudspeaker modules 1_LO, 1_LU, 1_RO and 1_RU.

FIG. 5 shows a sectional view through a flat loudspeaker arrangement 16 with a frame 17 that is L-shaped towards the rear. It can be seen that a flat loudspeaker module 1 is connected to each of outer crosspieces 17, which, in this embodiment, is integrated with its module frame in the frame of flat loudspeaker arrangement 16. The module frame thus consists at least partially of frame 17 of flat loudspeaker arrangement 16. However, it is also conceivable that flat loudspeaker module 1 also forms a completely independent, separate element with its frame, with frame 2 being connected to frame 17 of flat loudspeaker arrangement 16.

It can further be seen that in this exemplary embodiment at least some of bass loudspeakers 19 are formed as a passive loudspeaker by a diaphragm 22 that cannot be deflected actively.

Adjoining loudspeaker driver 7 is connected to module frame 2 or frame 17 of flat loudspeaker arrangement 16 by means of a metal plate fastening on the rear. This is illustrated and described in detail in FIG. 1, and included by reference.

Loudspeaker chassis 8 of loudspeaker driver 7 is connected to a coaxial driver 18, the loudspeaker chassis 8 of which is in turn connected to frame 17 of flat loudspeaker arrangement 16 or optionally to module frame 2 of the loudspeaker module.

The arrangement and fastening of loudspeaker driver 7 can be seen more clearly in detail view b), in particular the fastening on the right side with loudspeaker chassis 8 of coaxial driver 18.

The enlarged detail c) shows the edge region of frame 17 of flat loudspeaker arrangement 16. It can be seen that the end faces of the L-shaped edge region of frame 17 tapers towards the back, which leads to formation of an inclined surface 23 around which a covering (not shown) made of fabric can be pulled from the front side to the rear side. Adjoining the end face is a groove 24 which has clamping means 25 for the positive fastening of a fabric pulled over the front side of flat loudspeaker arrangement 16 for covering. The fabric can thus be laid over the front side of frame 17, stretched and laid over inclined surface 23 into groove 24. The fabric is then clamped into groove 24 by means of clamping means 25. This means that the fabric is positively and detachably fastened and can thus be easily stretched, installed and replaced.

A lighting arrangement 26 is furthermore provided on the rear side in the side area of frame 17 or the L-shaped frame strip milled there. Said lighting arrangement 26 can be inserted into a preferably circumferential groove 27 and can be designed as an LED light strip. Lighting arrangement 26 can preferably have multiple light sources for emitting different colors in order to provide lighting that is adapted to requirements not only in terms of brightness but also in terms of color impression in this way.

It is conceivable in this case that flat loudspeaker arrangement 16 has or is connected to control electronics that controls lighting arrangement 26 depending on the sound emitted. It is also conceivable, however, that lighting arrangement 26 is coupled to a room light control system in order to influence the lighting of the room in which flat loudspeaker arrangement 16 is installed, either wired or wirelessly.

FIG. 6 shows a detail view of a section through loudspeaker driver 7 from FIG. 5 and the detail representation b) presented there. Reference is also made to the representation in FIG. 1.

It can be seen that loudspeaker chassis 8 is connected at the rear side to metal plate 14 on rear side plate 4 of module housing 2 or frame 17 of flat loudspeaker arrangement 16.

Loudspeaker driver 7 is also screwed to loudspeaker chassis 8 from the inside on the front outer periphery of loudspeaker chassis 8 with front plate 3 of module housing 2 or frame 17 of flat loudspeaker arrangement 16. This can be done, for example, by means of wood screws that immerse into the edge region of front plate 3 adjacent to front opening 6a.

Another fastening instead of using wood screws 28, for example by means of machine screws and an associated nut, for example in the form of a drive-in sleeve or a screw connection from the front side, is also conceivable.

The same applies to the fastening of metal plate 14 to rear side plate 4, which can be done, for example, with machine screws or also by means of wood screws or the like.

FIG. 7 shows a detail view of the section of L-shaped frame 17 corresponding to the representation c) in FIG. 5. It shows more clearly groove 24 with clamping element 25 for fastening the fabric (not illustrated) intended for covering the front side of flat loudspeaker arrangement 16. Clamping arrangement 25 can have elastically deflectable fingers introduced into the groove, between which a rod is clamped. The rod is at least partially surrounded by the fabric in order to clamp the fabric between the rod and the clamping fingers.

Groove 27 with lighting arrangement 26 inserted therein can also be seen. Said lighting arrangement 26 can be designed, for example, as LED light strips inserted circumferrentially at the rear side of frame 17. Lighting arrangement 26 radiates towards the rear side onto the wall, where flat loudspeaker arrangement 16 can be attached. As a result, indirect light is emitted, with inclined surface 23 on the lateral end face improving the radiation.

FIG. 8 shows a sectional view of a loudspeaker driver 7, which can be designed, for example, as a bass or midrange driver for the corresponding frequency range. It can be seen that diaphragm 12 is guided from the outer periphery on the front side of loudspeaker chassis 8 towards the center to the rear side and is there in turn connected to loudspeaker chassis 8 with an elastic area 29.

On the sound radiation side, i. e. towards the front side of diaphragm 12, magnetic driver 9 with its magnet is arranged in front of diaphragm 12. Here, magnetic driver 9 is screwed to loudspeaker chassis 8. Voice coil 11, which is coupled to diaphragm 12, is immersed into the circumferential slot of magnetic driver 9.

In the exemplary embodiment illustrated, an additional coaxial driver 18 is arranged in the center of loudspeaker driver 7. In this case, horn 30 of coaxial driver 18 is aligned with diaphragm 12 towards the sound outlet side, i. e. towards the front side of loudspeaker driver 7.

It can be seen that coaxial driver 18 is connected to loudspeaker chassis 8 of loudspeaker driver 7. Said coaxial driver 18 can be designed as a separate element, i. e. as a separately functional loudspeaker driver and at the same time carries magnetic driver 9 for loudspeaker driver 7. This coaxial driver 18 thus provides a functional element for loudspeaker driver 7 to which coaxial driver 18 is connected in the form of magnetic driver 9.

FIG. 9 shows a side sectional view of a flat loudspeaker module 1 corresponding to the illustration in FIG. 1. Therefore, reference can essentially be made to the description provided there.

It can be seen that loudspeaker driver 7 has an air duct 31 in its center. This allows an air flow L indicated by arrows to pass from the rear side to the front side, which forms the sound outlet side, through which loudspeaker driver 7 is cooled.

FIG. 10 shows a modified embodiment of flat loudspeaker module 1, in which, in addition to air duct 31 in FIG. 9, a fan 32 (ventilator) is also built into central air duct 31. This allows the air flow L to be additionally forced and controlled. For example, the heating of loudspeaker driver 7 can be measured by means of a thermometer, and fan 32 can be controlled depending on the loudspeaker driver temperature. The temperature can be measured directly on loudspeaker driver 7 or indirectly in its surroundings. However, it is also conceivable that fan 32 is controlled depending on the power supplied to loudspeaker driver 7 and/or depending on the operating time of loudspeaker driver 7.

FIG. 11 shows a front view of flat loudspeaker modules M1, M2, M4 with dimensions based on a common grid dimension.

Illustration a) depicts a square first module M1 with a height and width corresponding to the smallest grid dimension.

Illustration b) shows a rectangular second module M2, which corresponds to twice the grid dimension. The height is twice the grid dimension, and the width is the grid dimension.

Illustration c) shows a square third module that corresponds to four times the grid dimension. Both the height and the width are twice as large as the grid dimension.

In a corresponding manner, further variants of the modules are conceivable, which correspond to a multiple x of the grid dimension in relation to the height and width of modules Mx.

Due to the uniform grid dimension of, for example, approx. 60×60 cm, an arrangement of sound-influencing modules can optionally be put together in such a way that the combination of the acoustic characteristics of the modules leads to the desired acoustic characteristics and the arrangement has the desired area. This area can be utilized as a screen for the visual projection of images or films by covering the front side with a sound-permeable fabric, for example. The fabric can also be printed or painted, so that the sound-influencing module arrangement can also be used as a design element.

The depth of the flat sound-influencing modules is significantly smaller than the grid dimension. The depth of a flat module can, for example, be selected so that it is a maximum of 20% of the grid dimension. The depth is preferably selected in the range of 10 to 20% of the grid dimension and can, for example, be 70 mm for a grid dimension of 600 mm.

FIG. 11 shows in exemplary fashion active flat panel loudspeaker modules with an arrangement of loudspeaker drivers 7, such as, for example, a horn loudspeaker 18 as a tweeter, at least one midrange speaker 19 and at least one woofer 20. To control the multiple loudspeaker drivers 7, control electronics with suitable frequency filters can be integrated into the active flat panel loudspeaker module.

It is conceivable that a pair of loudspeaker drivers arranged next to one another, which are tuned to the same frequency range, can be controlled with a time delay relative to one another by means of delay electronics. This delay (D=Delay) in the radiation by one of the two loudspeaker drivers leads to an effect that can be perceived acoustically as a tilting of the radiation direction. This means that the radiation characteristics of the flat panel loudspeaker module can be changed, for example, by actuating a delay switch of the control electronics.

In case of second module M2, the radiation direction would result in the sound being emitted diagonally downwards if the lower loudspeaker driver were delayed (see arrow D). If the second module M2 were rotated by 180°, it would then emit sound diagonally upwards. A rotation of 90°, on the other hand, would result in sound being emitted diagonally to the right or diagonally to the left.

Diagonally downwards/upwards/right/left means radiation from the front side to the front with a radiation angle that is aligned diagonally from the horizontal radiation plane in the respective direction and determined by the delay time.

In third module M4, a delay of both right loudspeaker drivers results in a radiation angle of the sound signal emitted by the loudspeaker drivers being aligned diagonally to the right. If only one of the loudspeaker drivers is delayed, a radiation direction that is diagonally to the right and downwards or diagonally to the right and upwards can also be set. By varying the orientation of flat loudspeaker module M4 in a module arrangement in 90° steps, the radiation direction rotates accordingly. In this way, a variety of active flat loudspeaker arrangements can be put together using the three standard modules shown as examples, so that numerous acoustic characteristics can be achieved by selecting, positioning and orienting the sound-influencing modules as well as the orientation of the loudspeaker drivers installed in them and, if necessary, a delay that is switched on.

FIG. 12 shows a side view of the square flat loudspeaker module M1 with the dimensions of the grid dimension of approx. 600×600 mm from FIG. 11. It can be seen that grooves 33 have been incorporated on the narrow side surfaces of the loudspeaker module housing. These can be used to run electrical cables between the modules when sound-influencing modules are joined flush with one another.

FIG. 13 shows a front view of the square flat loudspeaker module M1 with the dimensions of the grid dimension from FIG. 11 in different orientations of flat loudspeaker module M1 or its loudspeaker inserts.

In the first basic variant a), midrange speaker 19, tweeter 18 and woofer 20 are positioned vertically from top to bottom. Control electronics 34 is located, for example, to the left of woofer 20 under a screwed-on cover plate. The horizontal radiation characteristics is thus primarily supported by the oval shape of the tweeter's horn shell, which extends horizontally with its longer side.

In the second orientation b), the basic variant a) is rotated 90° to the left, so that the arrangement of midrange speaker 19, tweeter 18 and woofer 20 is now aligned horizontally next to one another. This supports a vertical radiation characteristic due to the alignment of the horn shell now rotated by 90°.

In the third variant c), the basic variant is modified by rotating the upper loudspeaker insert consisting of midrange speaker 19 and tweeter 18 by 90°. Woofer 20 continues to operate on the lower listening level, while the alignment of midrange speaker 19 and tweeter 18 enhances the vertical radiation characteristics through the vertical alignment of the oval horn shell of tweeter 18.

In a corresponding manner, a wide range of variations are possible by further rotations in order to achieve a desired radiation characteristic with standard flat loudspeaker module M1.

FIG. 14 shows a front, side and rear view of a diffuser module 36, which also has dimensions in grid dimension, for example approx. 600×600 mm, or a multiple thereof. This can ensure that the sound is distributed more evenly in space. Diffuser module 36 has a plurality of crosspieces 37, which are arranged in a matrix or checkerboard pattern spaced apart from one another and intersecting at intersection points in a diffuser frame 38. In the exemplary embodiment, diffuser frame 38 has no grooves, since an electrical cable feed is only required for the active flat loudspeaker modules. Optionally, grooves can also be made on the narrow sides of diffuser frame 38. This allows the space for cable routing to be increased and, even with a system consisting only of passive sound-influencing modules, a cable routing to, for example, lights in the frame can be implemented.

The grid dimensions allow a wide range of configurations of the arrangement to be implemented, such as, for example, a dual channel stereo characteristic with a medium size of 3,100×1,900×70 mm in 16:10 format, a 3.0 stereo characteristic with a large dimension of 5,500×3,100×70 mm and, based thereon, a 5.1 surround characteristic with additional satellite subwoofers, a 3.0 stereo characteristic with a very large dimension of 7,300×3,100×70 mm in 2.35:1 cinema format, a 5.0 surround system with surround sound with a large dimension of 5,500×3,100×70 mm in 16:9 format, and, based thereon, an immersive sound characteristic with additional satellite subwoofers.

FIG. 15 shows a front view of a first variant of a flat panel loudspeaker arrangement for the 16:10 format (computer screen format). It is made up of a matrix of three grid rows and five grid columns and has an active flat loudspeaker module M1 in the basic grid dimension, e. g. 600×600×70 mm, at the upper right and left corners. This achieves a dual channel stereo sound characteristic. The spaces between are filled with passive flat loudspeaker modules, i. e. absorber modules 21 or diffuser modules 36. These absorber modules 21 or diffuser modules 36 also have dimensions in the grid dimension or a multiple thereof, so that sound-influencing modules M1, M2, M4, 21, 36 can be joined together flush next to one another to form a flat arrangement. Sound-influencing modules M1, M2, M4, 21, 36 have fastening elements 40 on their edges, for example in the form of recesses for receiving a fastening plate and threaded holes, so that adjacent modules can be joined together with a fastening plate connecting the modules using fastening screws screwed into the threaded holes. Fastening elements 40 are symmetrical and equally spaced on the modules in a predetermined grid dimension. This means that fastening in the different orientations, i. e. 90° rotations, of the modules can be implemented independently.

This fastening results in a stable connection of the modules to form an arrangement of sound-influencing modules, which has an audio characteristic that depends on the selection, positioning and arrangement of the individual sound-influencing modules put together to form an arrangement.

The modules can be suspended from a wall, for example, using upper fastening elements 40. There, for example, tabs with an eyelet, L-shaped profiles for positive support on a wall rail, U-shaped threaded brackets for holding threaded rods or eyebolts or similar can be mounted.

A separate frame 41 can be fastened to the outer periphery of the sound-influencing modules, which can also have fastening elements 40 arranged symmetrically and equally spaced from one another corresponding to the sound-influencing modules. Frame 41 can thus be fastened to the sound-influencing modules using fastening elements 40 and adjacent fastening elements 40 of the sound-influencing modules. Frame 41 can be made up of multiple parts and can be assembled from a set comprising L-shaped elbow frame parts 42 and straight frame strip parts 43.

FIG. 16 shows a front view of a second variant of a flat panel loudspeaker arrangement for the 16:9 format (HDTV) with optional monophonic loudspeaker boxes 44 for surround sound. Five grid rows and nine grid columns are provided to stretch a screen/acoustic wall with dimensions of 5,500×3,100×70 mm. It is suitable for rooms up to 200 m² and a room height of up to 3.7 m. There are three active flat panel loudspeaker modules M2 with double grid dimension, which are aligned vertically with their double grid height. The spaces between are filled with passive sound-influencing modules with single, double and quadruple grid dimension. Absorber modules 21 are used in particular in this case. However, diffuser modules 36 can be used in selected grid segments to even out the surround sound.

FIG. 17 shows a front view of a third variant of a flat panel loudspeaker arrangement for the cinema format which is divided into five grid rows and twelve grid columns to implement a ratio of 2.35:1, for example with dimensions of 7,300×3,100×70 mm. Active flat loudspeaker modules M4 with quadruple grid dimension are used. And again, the spaces in between are filled with passive sound-influencing modules with double and quadruple grid dimension. The rectangular sound-influencing modules with double grid dimension are aligned horizontally or vertically depending on the segment to be filled. This combined screen and acoustic wall is suitable for medium and large rooms up to 350 m² and room heights up to 4 m, such as, for example, a cinema hall.

By additionally distributing subwoofers throughout the room, which can also have tweeters and midrange speakers, a surround sound characteristic can be achieved.

FIG. 18 shows a front view of a fourth variant of a flat panel speaker arrangement for the 16:9 format with immersive, room-filling sound and optional additional monophonic loudspeaker boxes for surround sound. This makes it possible to implement a 5.0 surround system in which the small active flat loudspeaker modules M1 act as reflective “phantom” surround sound loudspeakers. The surround sound can be further improved by additional optional sub-loudspeakers 44, which are distributed around the room.

This acoustic wall can have a size of 5,500×3,100×70 mm and is particularly suitable for medium-sized rooms up to 200 m² and room heights up to 3.7 m.

FIG. 19 shows a top view of different frame elements 42, 43 of a set for forming a frame 41 for the arrangements that can be assembled in different dimensions using the grid dimension.

It can be seen that an L-shaped elbow 42 with isosceles strips is provided to form frame 41 at the corner areas. The inner dimension of the length of the strips can correspond to the grid dimension, e. g. 600 mm, or preferably a factor thereof. In the exemplary embodiment illustrated, the outer dimensions are 350×350 mm, with the inner dimension of 300 mm corresponding to half the grid dimension.

Furthermore, the set of frame elements has straight frame strip parts 43 of different lengths with the grid dimension and a multiple thereof. Thus, single frame strips R1 with single grid dimension of e. g. 600 mm, double frame strips R2 with double grid dimension, e. g. 1,200 mm, triple frame strips R3 with triple grid dimension, e. g. 1,800 mm, and quadruple frame strips R4 with quadruple grid dimension, e. g. 2,400 mm, are included in the set. By selecting the appropriate frame parts, a frame 41 can be put together with the size required for the arrangement of sound-influencing modules, wherein the individual frame parts are fastened to the adjacent sound-influencing modules using their fastening elements 40, e. g. fastening plates and fastening screws, and the fastening elements 40 of the adjacent sound-influencing modules.

These frame parts can have a groove and fastening elements on their rear side, as shown in FIG. 5 a), for fastening a screen stretched over the front of the arrangement and/or a lighting arrangement (e. g. LED strips).

FIG. 20 shows a top view of various embodiments of horn shells 45, which have a horn neck 46 or can be coupled to the output of a separate horn neck of a loudspeaker driver. A horn mouth 47 is connected to horn neck 46 in the direction of view towards the front.

In variant a), it is aligned asymmetrically to the side, so that the sound is directed diagonally to the front right, or diagonally to the front left when rotated by 180°. When the horn shell 45 is aligned vertically, i. e. when rotated by 90°, the sound is directed asymmetrically diagonally upwards or downwards.

In variant b), horn mouth 47 is aligned symmetrically. However, there are crosspieces 48 in the horn mouth that are spaced apart from one another and extend in the direction of the longer extension of horn shell 45. They are set at an angle in the direction of sound propagation, i. e. in the direction of view, in order to radiate the sound diagonally downwards or, if horn shell 45 is rotated by 180°, diagonally upwards. If the horn shell is rotated by 90°, a radiation direction diagonally to the right or left side in each case can also be implemented in the same way.

Variant c) showed a symmetrical basic variant of the horn shell with a primarily horizontally forward-facing radiation characteristic.

FIG. 21 shows a sketch of a horn shell 45 with magnetic fastening above an associated loudspeaker driver 7. At least one magnetic fastening element 49 is arranged on loudspeaker driver 7 or the loudspeaker module housing (not shown), which is preferably a permanent magnet. Horn shell 45 can be made of a metal sheet which is detachably connected to magnetic fastening element 49 when placed on it. Sketched horn neck 46 can be part of horn shell 45, part of loudspeaker driver 7 or an additional separate part which is positioned between and connected to loudspeaker driver 7 and horn shell 45.

1. A flat loudspeaker module, comprising:
a loudspeaker module housing;
at least one loudspeaker driver, wherein the at least one loudspeaker driver comprises
a loudspeaker chassis,
a diaphragm, and
a magnetic driver which is coupled to the diaphragm for exciting vibrations, wherein the magnetic driver and is arranged in front of the diaphragm on a loudspeaker front side of the loudspeaker module housing forming a sound outlet side,
wherein the loudspeaker chassis comprises a fastening means for fastening a loudspeaker to the loudspeaker module housing on a loudspeaker rear side of the loudspeaker module housing diametrically opposite the sound outlet side.

2. The flat loudspeaker module according to claim 1, wherein the loudspeaker chassis is connected to a metal plate by the fastening means, and wherein the metal plate is connected to the loudspeaker module housing at opening edges on the loudspeaker rear side of the loudspeaker module housing.

3. The flat loudspeaker module according to claim 1 wherein the fastening means has threaded openings for receiving at least one fastening screw.

4. The flat loudspeaker module according to claim 1 wherein the at least one loudspeaker driver includes a plurality of loudspeaker drivers, and wherein at least one of the plurality of loudspeaker drivers is connected to the loudspeaker chassis at the loudspeaker front side of the loudspeaker module housing.

5. The flat loudspeaker module according to claim 1 wherein the at least one loudspeaker deriver includes a plurality of loudspeaker drivers, and wherein at least one of the plurality of loudspeaker drivers has a central air duct which runs from the loudspeaker rear side to the loudspeaker front side forming the sound outlet side, and which extends through the magnetic driver.

6. The flat loudspeaker module according to claim 5, further comprising a fan is arranged in the air duct.

7. The flat loudspeaker module according to claim 1 further comprising a coaxial driver arranged on the magnetic driver, wherein the coaxial driver has a horn open towards the sound outlet side.

8. The flat loudspeaker module according to claim 7, further comprising at least one magnetic fastening element for detachably fastening a first horn shell of the horn by magnetic force on the flat loudspeaker module.

9. The flat loudspeaker module according to claim 8, wherein the first horn shell comprises a horn mouth opening asymmetrically in a width direction of the first horn shell according to a selected orientation during magnetic fastening to a right side or a left side, and further comprising
a second horn shell with a radiation characteristic influenced upwards or downwards asymmetrically in a height direction of the second horn shell according to a selected orientation during magnetic fastening by crosspieces extending in the width direction of the second horn shell and positioned at an angle, or
a third horn shell comprising a horn mouth opening symmetrically.

10. The flat loudspeaker module according to claim 1 further comprising at least one asymmetrical tweeter.

11. The flat loudspeaker module according to claim 1 wherein the loudspeaker module housing has a groove on at least one narrow side wall extending over an entire length of the at least one narrow side wall.

12. The flat loudspeaker module according to claim 11, further comprising at least one loudspeaker driver is arranged in the groove.

13. An arrangement comprising multiple separately functional sound-influencing modules,
wherein each of the sound-influencing modules comprise a flat module housing, wherein a depth of the flat module housing is the same for all sound-influencing modules,
wherein each of the sound-influencing modules are selected from the group consisting of active flat loudspeaker modules, absorber modules, and diffuser modules,
wherein each of the sound-influencing modules comprise fastening elements arranged symmetrically and equally spaced at edge regions, and
wherein each of the sound-influencing modules have a dimension in height and width that corresponds to a common grid dimension or a multiple thereof.

14. The arrangement according to claim 13, wherein a group of the sound-influencing modules comprises
at least one flat loudspeaker module according to claim 1, and
absorber modules having absorber material, and/or
diffuser modules designed as sound diffusers,
wherein diffuser modules present in areas of the sound-influencing modules that are arranged next to one another in a grid dimension and connected to one another, are not occupied by flat loudspeaker modules.

15. The arrangement according to claim 13 further comprising a frame on a periphery of the sound-influencing modules, wherein the sound-influencing modules are arranged next to one another, wherein the sound-influencing modules are selected from the group consisting of flat loudspeaker modules, absorber modules, and diffuser modules, wherein the frame is connectable to the sound-influencing modules by fastening elements arranged in each case symmetrically and equally spaced on the frame and the sound-influencing modules.

16. The arrangement according to claim 15, wherein the frame is made up of multiple parts, wherein the multiple parts are connectable to the sound-influencing modules on a periphery of sound-influencing modules arranged next to one another by fastening elements arranged symmetrically and equally spaced in each case on the multiple frame parts and the sound-influencing modules.

17. The arrangement according to claim 15 wherein the frame is covered with a fabric on its front side forming the sound outlet side.

18. The arrangement according to claim 15 wherein the frame comprises a lighting arrangement.

19. The arrangement according to claim 15 wherein the frame has a groove with a clam in a rear side area for clamping a fabric that is stretchable over a front side of the arrangement.

20. The arrangement according to claim 15 further comprising a coaxial driver with a horn open towards a sound outlet side, and at least one magnetic fastening element for detachably fastening a horn shell of the horn selectable from a set of different horn shells by magnetic force, wherein the at least one magnetic fastening element optionally is present in one of several possible orientations on the associated coaxial driver (18).

21. The arrangement according to claim 15 further comprising at least one flat loudspeaker module.
